(19) United States
(12) Patent Application Publication
(10) Pub. No.: US 2017/0284348 A1
(43) Pub. Date: Oct. 5, 2017

(54) AIR INTAKE APPARATUS

(71) Applicant: AISIN SEIKI KABUSHIKI KAISHA, Kariya-shi, Aichi-ken (JP)

(72) Inventor: Hideaki TERAMOTO, Kariya-shi, Aichi-ken (JP)

(73) Assignee: AISIN SEIKI KABUSHIKI KAISHA, Kariya-shi, Aichi-ken (JP)

(21) Appl. No.: 15/513,871

(22) PCT Filed: Sep. 25, 2015
(86) PCT No.: PCT/JP2015/077066

§ 371 Date: Mar. 23, 2017

(30) Foreign Application Priority Data
Oct. 17, 2014 (JP) 2014-212289

(51) Int. Cl. F02M 35/112; F02M 35/108; F02M 35/10

(52) U.S. Cl. CPC F02M 35/112; F02M 35/10072; F02M 35/1085; F02M 35/10091; F02M 35/104

(57) ABSTRACT

This air intake apparatus is mounted on an in-line multi-cylinder engine, and includes a surge tank that includes a throttle body mounting portion at a central portion thereof, one air intake pipe, which is single, and the other air intake pipe, which is single, connected to one end and the other end of the surge tank in a left-right direction, respectively, a first air intake pipe group that is connected to the one air intake pipe and includes a plurality of branched air intake pipes, and a second air intake pipe group that is connected to the other air intake pipe and includes the same number of branched air intake pipes as the plurality of branched air intake pipes.

### TECHNICAL FIELD

The present invention relates to an air intake apparatus, and more particularly, it relates to an air intake apparatus mounted on an in-line multi-cylinder engine.

### BACKGROUND ART

In general, an air intake apparatus mounted on an in-line multi-cylinder engine is known. Such an air intake apparatus is disclosed in Japanese Patent Laying-Open No. 7-253062, for example.

In Japanese Patent Laying-Open No. 7-253062, there is disclosed an intake manifold (air intake apparatus) for an in-line four-cylinder engine. This intake manifold described in Japanese Patent Laying-Open No. 7-253062 includes a surge tank having a substantially isosceles triangular (chevron) cross-section and four air intake pipes connected to the surge tank. A throttle body mounting seat (throttle body mounting portion) is provided on the upper surface of the surge tank, and two air intake pipes are connected to each of two surfaces (a right side surface and a left side surface of the surge tank perpendicular to the upper surface) corresponding to sides having lengths equal to each other through a vertex angle of the isosceles triangle. One of the two air intake pipes on one side (the right side surface or left side surface) is connected closer to the vertex angle along a direction in which the equal side extends, and the other of the two air intake pipes on one side is connected closer to a basic angle along the direction in which the equal side extends. The throttle body mounting seat is arranged at a position on the upper surface of the surge tank, which has a substantially isosceles triangular shape, closer to the vertex angle.

### PRIOR ART

### Patent Document

Patent Document 1: Japanese Patent Laying-Open No. 7-253062

### SUMMARY OF THE INVENTION

### Problem to be Solved by the Invention

In the intake manifold described in Japanese Patent Laying-Open No. 7-253062, however, the throttle body mounting seat is arranged at the position on the upper surface of the surge tank closer to the vertex angle, and the air intake pipes are connected closer to the vertex angle and closer to the basic angle along the directions in which the right and left equal sides extend such that intake air path lengths from an air intake on the upper surface of the surge tank to right and left air intake pipe connections arranged closer to the vertex angle are relatively short while intake air path lengths from the air intake on the upper surface of the surge tank to right and left air intake pipe connections arranged closer to the basic angle are relatively long. Thus, even when air distribution in a left-right direction with respect to the throttle body mounting seat is good, a difference is made between the amount of air distributed to the air intake pipe closer to the vertex angle and the amount of air distributed to the air intake pipe closer to the basic angle on the right side surface or the left side surface. Therefore, there is such a problem that the amount of air distributed from the surge tank to each of the air intake pipes connected to the in-line multi-cylinder engine varies.

The present invention has been proposed in order to solve the aforementioned problem, and an object of the present invention is to provide an air intake apparatus capable of suppressing variation in the amount of air distributed from a surge tank to each of air intake pipes connected to the surge tank.

### Means for Solving the Problem

In order to attain the aforementioned object, an air intake apparatus according to an aspect of the present invention is mounted on an in-line multi-cylinder engine, and includes a surge tank that includes a throttle body mounting portion at a central portion thereof, one air intake pipe, which is single, and the other air intake pipe, which is single, connected to one end and the other end of the surge tank in a left-right direction, respectively, a first air intake pipe group that is connected to the one air intake pipe and includes a plurality of branched air intake pipes, and a second air intake pipe group that is connected to the other air intake pipe and includes the same number of branched air intake pipes as the plurality of branched air intake pipes.

As hereinabove described, the air intake apparatus according to this aspect of the present invention includes the one air intake pipe, which is single, and the other air intake pipe, which is single, connected to the one end and the other end of the surge tank in the left-right direction, respectively, the first air intake pipe group that is connected to the one air intake pipe and includes the plurality of branched air intake pipes, and the second air intake pipe group that is connected to the other air intake pipe and includes the same number of branched air intake pipes as the plurality of branched air intake pipes. Thus, the one air intake pipe, which is single, is connected to the one end of the surge tank in the left-right direction while the other air intake pipe, which is single, is connected to the other end of the surge tank in the left-right direction, and hence an intake air path length from an air intake of the surge tank to a connection of the one air intake pipe and an intake air path length from the air intake of the surge tank to a connection of the other air intake pipe can be equal to each other. Therefore, intake air taken into the surge tank can be equally distributed to the one air intake pipe and the other air intake pipe. Consequently, variation in the amount of air distributed from the surge tank to each of the one air intake pipe and the other air intake pipe connected to the surge tank can be suppressed. Furthermore, the intake air can be properly distributed to each of the plurality of air intake pipes, which the first air intake pipe group includes, through the one air intake pipe, which is single, and the intake air can be properly distributed to each of the plurality of air intake pipes, which the second air intake pipe group includes, through the other air intake pipe, which is single.

In the aforementioned air intake apparatus according to this aspect, an air intake pipe length from an end of the one air intake pipe closer to the surge tank to a tip end of an individual air intake pipe in the first air intake pipe group is preferably equal to an air intake pipe length from an end of the other air intake pipe closer to the surge tank to a tip end of an individual air intake pipe in the second air intake pipe group. According to this structure, intake air path lengths from an exit of the surge tank to the respective tip ends of the air intake pipes branched in correspondence to cylinders of the in-line multi-cylinder engine can be equal to each other. Thus, equidistributivity of the intake air to the first air intake pipe group and the second air intake pipe group connected to the one air intake pipe and the other air intake pipe, respectively can be effectively improved while variation in the amount of air distributed from the surge tank to the one air intake pipe and the other air intake pipe connected to the surge tank can be suppressed.

In the aforementioned air intake apparatus according to this aspect, the surge tank preferably further includes a convex portion configured such that a portion of an inner bottom surface that corresponds to a position provided with the throttle body mounting portion protrudes inward of the surge tank with respect to inner bottom surfaces of the one end and the other end of the surge tank in the left-right direction. According to this structure, in the air intake apparatus in which external gas (blow-by gas (PCV gas), exhaust gas (EGR gas), or the like) recirculated to the engine is introduced together with the intake air (fresh air) into the surge tank, oil (engine oil) and moisture contained in the above external gas can be prevented by the convex portion from being accumulated in a region in the surge tank where the intake air is taken. Therefore, the oil and moisture accumulated in the surge tank can be prevented from being splashed due to flow of the intake air taken quickly upon start of the engine and adhering to a throttle valve in the vicinity of the throttle body mounting portion. Consequently, fixation of the throttle valve caused by adhesion of a deposit formed by altering an oil component to the throttle valve can be prevented. Furthermore, malfunction (fixation) of the throttle valve caused by freezing of the moisture at the time of start of the engine in a cold region can be prevented.

In the aforementioned air intake apparatus according to this aspect, portions of the one air intake pipe and the other air intake pipe connected to the surge tank are preferably provided in the vicinity of lowermost portions of the one end and the other end of the surge tank in the left-right direction, respectively. According to this structure, in the air intake apparatus in which the external gas (blow-by gas (PCV gas), exhaust gas (EGR gas), or the like) recirculated to the engine is introduced together with the intake air (fresh air) into the surge tank, the oil and moisture contained in the external gas accumulated in the surge tank can be continuously sucked out through the one air intake pipe and the other air intake pipe provided in the vicinity of the lowermost portions of the one end and the other end of the surge tank. In other words, a state where excessive amounts of oil and moisture are accumulated in the surge tank can be avoided. Therefore, generation of white smoke caused by combustion of a large amount of oil sucked by negative pressure at the time of start of the engine in a combustion chamber and generation of accidental fire in the combustion chamber caused by a large amount of water sucked by negative pressure at the time of start of the engine can be prevented.

In the aforementioned air intake apparatus according to this aspect, an external gas introduction portion that introduces external gas is preferably provided at the central portion of the surge tank, and an external gas passage that distributes, to left and right sides, the external gas introduced from the external gas introduction portion is preferably provided inside the surge tank. According to this structure, the external gas introduced from the external gas introduction portion can be mixed with the intake air while being properly distributed to each of the one air intake pipe and the other air intake pipe connected to the one end and the other end of the surge tank in the left-right direction, respectively, through the external gas passage. At this time, the blow-by gas (PCV gas) containing oil is prevented from directly contacting with the intake air (fresh air) immediately after the intake air is taken through the throttle body mounting portion at the central portion of the surge tank and being entrained in the intake air, and hence fixation of the throttle valve caused by adhesion of the deposit formed by altering the oil component to the throttle valve can be prevented. Furthermore, direct contact of the exhaust gas (EGR gas) containing moisture is prevented, and hence blocking of an inlet of the external gas passage to the surge tank caused by freezing of the moisture in the vicinity of the inlet at the time of operation of the engine in a cold region can be prevented.

In the aforementioned structure in which the external gas passage is provided inside the surge tank, an air intake apparatus body including the surge tank is preferably formed by facing and bonding a first member and a second member to each other, and the external gas passage is preferably formed in a region where a first inner wall surface of the first member that extends toward the second member and a second inner wall surface of the second member that extends toward the first member overlap each other. According to this structure, the external gas can be easily distributed into the surge tank through the external gas passage including a region sandwiched between the first inner wall surface and the second inner wall surface.

In the aforementioned structure in which the surge tank further includes the convex portion, an external gas passage that distributes, to left and right sides, external gas introduced from an external gas introduction portion that introduces the external gas is preferably provided inside the surge tank, and external gas introduction regions to the surge tank in the external gas passage are preferably arranged at positions spaced apart in the left-right direction from a position in the surge tank that corresponds to a top of the convex portion on the inner bottom surface. According to this structure, when the external gas is introduced together with the intake air (fresh air) into the surge tank through the external gas introduction portion, oil mist in a liquid drop form contained in the external gas can be prevented by the convex portion from being accumulated in a region (a region in the vicinity of the inner bottom surface at the central portion) in the surge tank where the intake air is taken.

### Effect of the Invention

According to the present invention, as hereinabove described, the air intake apparatus capable of suppressing variation in the amount of air distributed from the surge tank to each of the air intake pipes connected to the surge tank can be provided.

### BRIEF DESCRIPTION OF THE DRAWINGS

FIG. 1 A perspective view showing a state where an air intake apparatus according to an embodiment of the present invention is mounted on an in-line four-cylinder engine.

FIG. 2 A diagram showing the structure of the air intake apparatus according to the embodiment of the present invention.

FIG. 3 A perspective view of an upper piece constituting an air intake apparatus body according to the embodiment of the present invention as viewed from the inner side thereof.

FIG. 4 A perspective view showing a lower piece constituting the air intake apparatus body according to the embodiment of the present invention as viewed from the inner side thereof.

FIG. 5 A sectional view showing the inner structure of a surge tank (body) when the air intake apparatus body is vertically cut in a state where the air intake apparatus according to the embodiment of the present invention is mounted on the in-line four-cylinder engine.

FIG. 6 A sectional view showing the inner structure of the surge tank (body) in the case of horizontal cutting at the height position of a blow-by gas inlet in the air intake apparatus according to the embodiment of the present invention.

FIG. 7 A sectional view of the surge tank taken along the line 150-150 in FIG. 2.

FIG. 8 A sectional view of the surge tank taken along the line 160-160 in FIG. 2.

FIG. 9 A perspective view showing the structure of a blow-by gas passage formed in the surge tank of the air intake apparatus according to the embodiment of the present invention.

### MODES FOR CARRYING OUT THE INVENTION

An embodiment of the present invention is hereinafter described on the basis of the drawings.

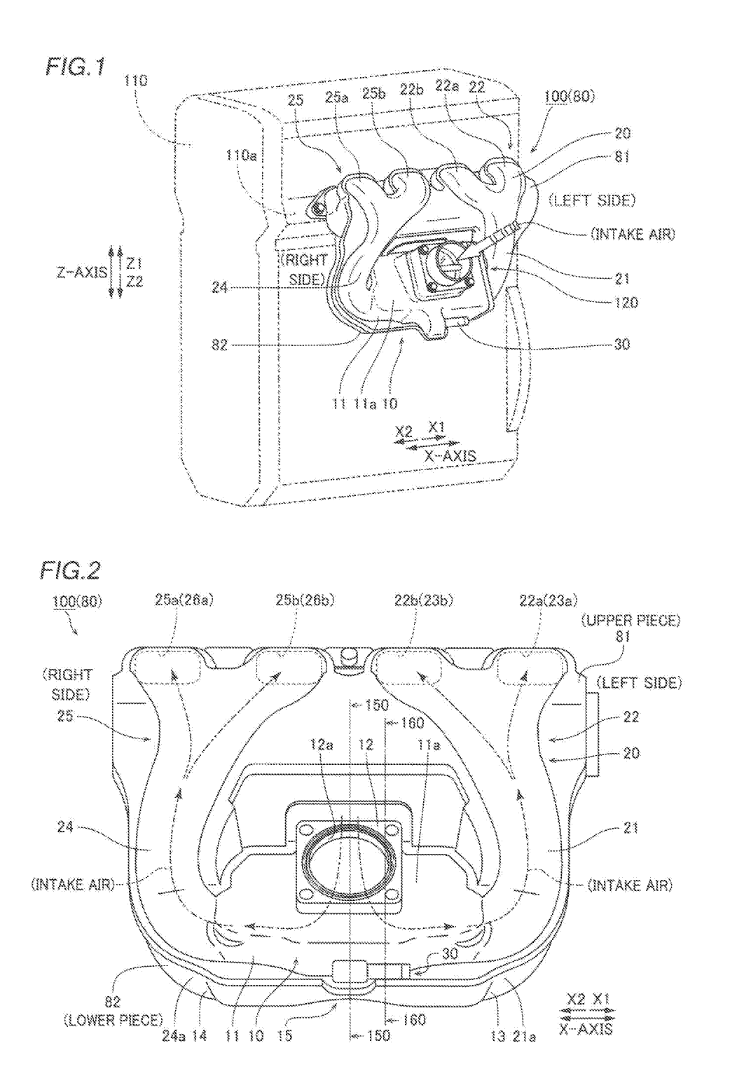

The structure of an air intake apparatus 100 according to the embodiment of the present invention is now described with reference to FIGS. 1 to 9. In the following description, it is assumed that each cylinder is arranged along an X-axis direction with respect to an engine 110. In addition, when the air intake apparatus 100 is viewed from the engine 110, an arrow X1 direction side is set to a “left side”, an arrow X2 direction side is set to a “right side”, and the up-down direction of the engine 110 is set to a Z-axis direction. The engine 110 is an example of an “in-line multi-cylinder engine” in the present invention. The X-axis direction is an example of a “left-right direction” in the present invention.

The air intake apparatus 100 according to the embodiment of the present invention is mounted on the in-line four-cylinder engine 110 (the outer shape is shown by a one-dot chain line), as shown in FIG. 1. The air intake apparatus 100 constitutes a part of an air intake system that supplies air to the engine 110, and includes an air intake apparatus body 80 including a surge tank 10 and an air intake pipe portion 20 arranged downstream of the surge tank 10.

In the air intake apparatus 100, intake air that reaches an air intake 12a (see FIG. 2) through an air cleaner (not shown) and a throttle valve 120 serving as an intake air path flows into the surge tank 10. The air intake apparatus 100 is mounted on a side wall 110a (shown by a two-dot chain line) of the engine 110 in a state where the throttle valve 120 is obliquely mounted on the air intake apparatus body 80 to be oriented downward from a horizontal position (a throttle body mounting portion 12 is oriented upward from a horizontal position).

Blow-by gas (PCV (positive crankcase ventilation) gas) is recirculated to the engine 110 through the air intake apparatus 100. Here, the blow-by gas denotes an unburned gas mixture containing hydrocarbons (combustion gas) that leaks from a clearance between the inner wall surface of a cylinder (not shown) and a piston (not shown) to a crank chamber (not shown) below the cylinder during driving of the engine 110.

After being discharged outward from the crank chamber, the blow-by gas is introduced into the air intake apparatus 100 through a PCV valve (not shown) in a state where particulate oil mist (engine oil) is separated by an unshown gas-liquid separator. The blow-by gas introduced into the air intake apparatus 100 contains a minor oil component that has not been completely removed by the gas-liquid separator. The structure of the air intake apparatus 100 into which the blow-by gas is introduced is described below in detail. The blow-by gas (PCV gas) is an example of “external gas” in the present invention.

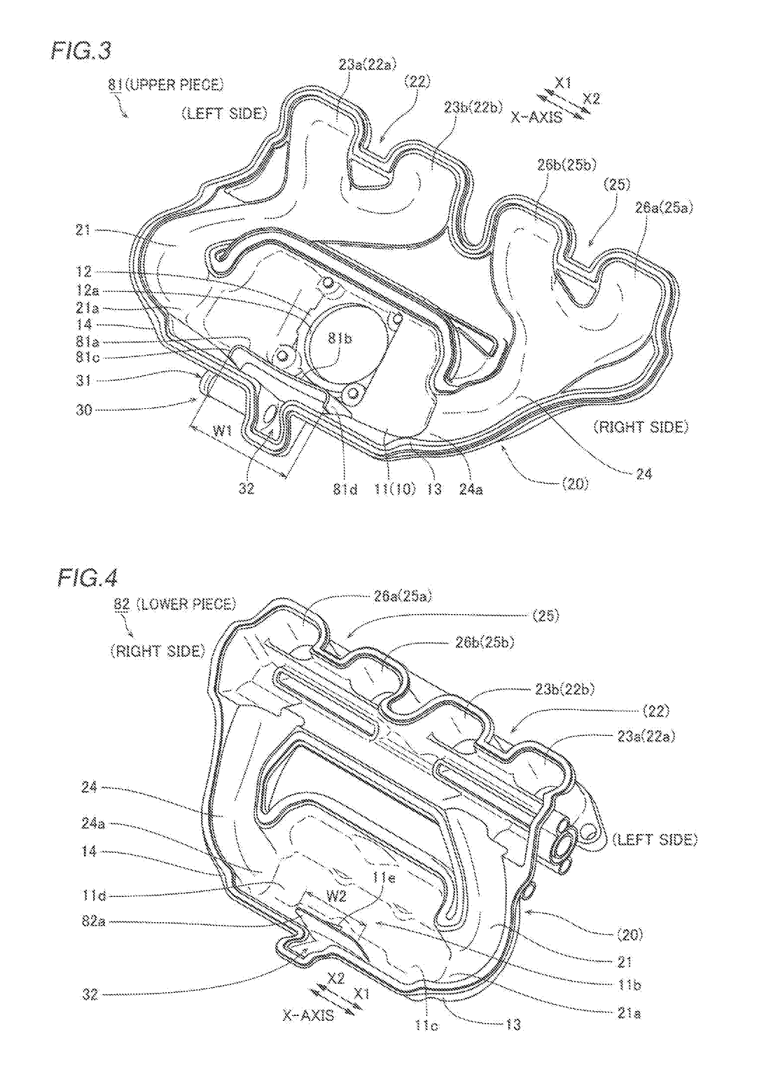

As shown in FIG. 2, both the surge tank 10 and the air intake pipe portion 20 that constitute the air intake apparatus body 80 are made of resin (polyamide resin, for example). In the air intake apparatus body 80, an upper piece 81 (see FIG. 3) in which an upper half of the surge tank 10 and an upper half of the air intake pipe portion 20 are integrally molded and a lower piece 82 (see FIG. 4) in which a lower half of the surge tank 10 and a lower half of the air intake pipe portion 20 are integrally molded are integrally bonded to each other by vibration welding, as shown in FIGS. 3 and 4. The upper piece 81 and the lower piece 82 are examples of a “first member” and a “second member” in the present invention, respectively.

As shown in FIG. 2, the surge tank 10 includes a hollow body 11 that extends along a cylinder bank (X-axis) of the engine 110 (see FIG. 1). A left half (X1 side) of the air intake pipe portion 20 connected to the body 11 is constituted by a single left main pipe 21 and a left air intake pipe group 22 connected to the left main pipe 21. Similarly, a right half (X2 side) of the air intake pipe portion 20 is constituted by a single right main pipe 24 and a right air intake pipe group 25 connected to the right main pipe 24.

The left air intake pipe group 22 includes two air intake pipes 22a and 22b into which the single left main pipe 21 is branched. Similarly, the right air intake pipe group 25 includes two air intake pipes 25a and 25b into which the single right main pipe 24 is branched. The left air intake pipe group 22 and the right air intake pipe group 25 have a bilaterally symmetrical shape. The left main pipe 21 and the right main pipe 24 are examples of “one air intake pipe” and “the other air intake pipe” in the present invention, respectively. The left air intake pipe group 22 and the right air intake pipe group 25 are examples of a “first air intake pipe group” and a “second air intake pipe group” in the present invention, respectively.

According to this embodiment, the throttle body mounting portion 12 including the air intake 12a is provided on the upper surface 11a side (a surface visible at the front side of the plane of the figure) of a central portion of the surge tank 10 in a direction (left-right direction: X-axis direction) in which the body 11 extends. In the air intake apparatus 100, the single left main pipe 21 is connected to a left end 13 (X1 side) of the surge tank 10 in the direction in which the body 11 extends, and the single right main pipe 24 is connected to a right end 14 (X2 side) of the surge tank 10 in the direction in which the body 11 extends. In this case, an intake air path length from the air intake 12a of the surge tank 10 to a connection (end 21a) of the left main pipe 21 and an intake air path length from the air intake 12a of the surge tank 10 to a connection (end 24a) of the right main pipe 24 are equal to each other.

According to this embodiment, the left main pipe 21 is branched into the air intake pipes 22a and 22b on the side (a downstream side in a direction of intake air flow) opposite to the side (end 21a side) of the left main pipe 21 connected to the body 11. Similarly, the right main pipe 24 is branched into the air intake pipes 25a and 25b on the side (the downstream side in the direction of intake air flow) opposite to the side (end 24a side) of the right main pipe 24 connected to the body 11. The left end 13 and the right end 14 are examples of “one end” and “the other end” in the present invention, respectively.

Therefore, inside the body 11, approximately half of the intake air taken into the surge tank 10 through the air intake 12a is distributed in a left direction (X1 side), and the remaining approximately half of the intake air is distributed in a right direction (X2 side). Then, the approximately half of the intake air is guided from the left end 13 to the left main pipe 21, and the remaining approximately half of the intake air is guided from the right end 14 to the right main pipe 24. Then, the intake air is further distributed to the air intake pipes 22a and 22b on the downstream side of the left main pipe 21 and further distributed to the air intake pipes 25a and 25b on the downstream side of the right main pipe 24.

As shown in FIG. 2, an air intake pipe length from the end 21a of the left main pipe 21 closer to the surge tank 10 to each of tip ends 23a and 23b of the air intake pipes 22a and 22b in the left air intake pipe group 22 is equal to an air intake pipe length from the end 24a of the right main pipe 24 closer to the surge tank 10 to each of tip ends 26a and 26b of the air intake pipes 25a and 25b in the right air intake pipe group 25.

In other words, an intake air path length from the end 21a of the left main pipe 21 that corresponds to a left exit of the surge tank 10 to the tip end 23a of the air intake pipe 22a branched toward a corresponding cylinder of the engine 110 (see FIG. 1) and an intake air path length from the end 21a of the left main pipe 21 to the tip end 23b of the air intake pipe 22a are equal to each other. An intake air path length from the end 24a of the right main pipe 24 that corresponds to a right exit of the surge tank 10 to the tip end 26a of the air intake pipe 25a branched toward a corresponding cylinder of the engine 110 (see FIG. 1) and an intake air path length from the end 24a of the right main pipe 24 to the tip end 26b of the air intake pipe 25b are equal to each other. The air intake pipe portion 20 is configured such that these four air path lengths are equal to each other.

Thus, the air intake apparatus body 80 is configured to take in intake air from the central portion of the surge tank 10 and guide, at the same flow rate (with one fourth), the intake air to the four air intake pipes 22a, 22b, 25a, and 25b through the single left main pipe 21 and the single right main pipe 24 connected to the left and right ends of the surge tank 10, as shown in FIG. 1.

According to this embodiment, in the surge tank 10, the inner surface (inner wall surface) of the body 11 is concavo-convex. Specifically, a convex portion 15 that is raised in an arrow Z1 direction is provided inside the surge tank 10, as shown in FIG. 5. The convex portion 15 is provided, whereby a portion of an inner bottom surface 11b that corresponds to a central portion of the body 11 formed with the throttle body mounting portion 12 (see FIG. 2) protrudes inward of the surge tank 10 with respect to the inner bottom surface 11c (X1 side) of the left end 13 and the inner bottom surface 11d (X2 side) of the right end 14 of the surge tank 10 in the left-right direction. Therefore, the inner bottom surface 11c and the inner bottom surface 11d are recessed in a concave shape relatively downward (arrow Z2 direction) with respect to the inner bottom surface 11b.

As shown in FIGS. 2, 4, and 5, the end 21a of the left main pipe 21 connected to the surge tank 10 is provided in the vicinity of the lowermost portion (arrow Z2 direction) of the left end 13 of the surge tank 10, and the end 24a of the right main pipe 24 connected to the surge tank 10 is provided in the vicinity of the lowermost portion (arrow Z2 direction) of the right end 14 of the surge tank 10. The ends 21a and 24a are examples of a “portion connected to the surge tank” in the present invention.

As described above, the blow-by gas (PCV gas) is introduced into the surge tank 10. Specifically, a blow-by gas supply portion 30 to which blow-by gas flows is integrally formed on a portion of the upper piece 81 that corresponds to the surge tank 10, as shown in FIGS. 2, 3, and 6.

The blow-by gas supply portion 30 includes a blow-by gas introduction portion 31 that is open outward (X1 side), an introduction chamber 32 connected to the blow-by gas introduction portion 31, in which blow-by gas is temporarily retained, and a blow-by gas passage 33 connected to the introduction chamber 32, in which a flow path is formed to supply (introduce) blow-by gas into the surge tank 10. The blow-by gas introduction portion 31 and the blow-by gas passage 33 are examples of an “external gas introduction portion” and an “external gas passage” in the present invention, respectively.

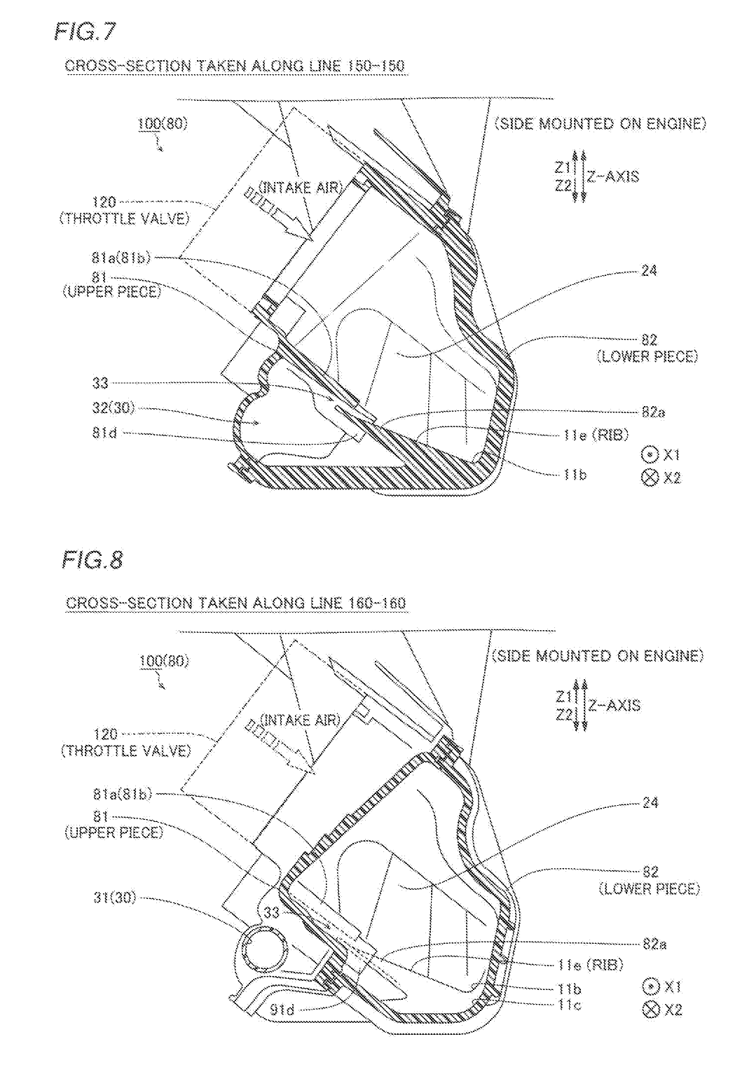

According to this embodiment, the blow-by gas passage 33 is configured to distribute the blow-by gas, which is introduced from the blow-by gas introduction portion 31, to the left and right sides (X1 and X2 sides). Specifically, the blow-by gas passage 33 is formed in a region where an inner wall 81a of the upper piece 81 that extends toward the lower piece 82 and an inner wall 82a of the lower piece 82 that extends toward the upper piece 81 overlap each other, as shown in FIGS. 7 to 9. The inner walls 81a and 82a are examples of a “first inner wall surface” and a “second inner wall surface” in the present invention, respectively.

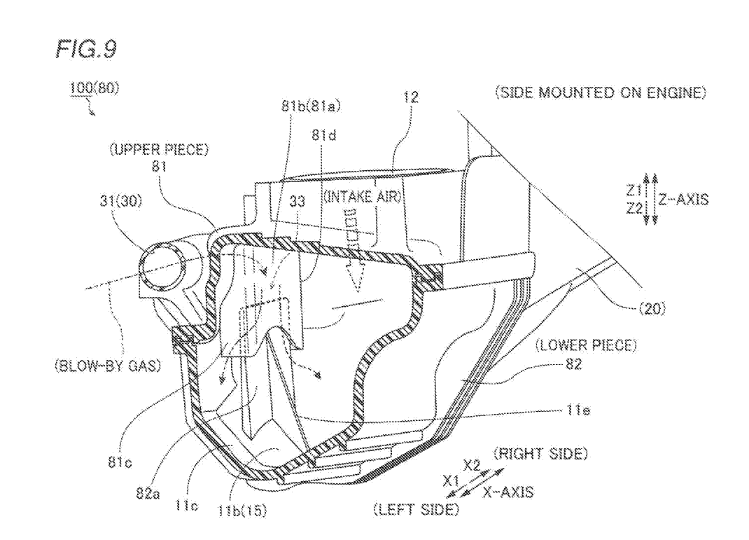

As shown in FIG. 4, the inner wall 82a of the lower piece 82 is in the form of a flat plate having a width W2 in the X-axis direction. A central portion of the inner wall 82a is connected to a rib 11e for reinforcement that extends from the portion of the inner bottom surface 11b that corresponds to the central portion of the body 11. On the other hand, the inner wall 81a of the upper piece 81 includes a flat plate-shaped central portion 81b and ends 81c (X1 side) and 81d (X2 side) bent by about 90 degrees toward the introduction chamber 32 at a predetermined bending radius with respect to the central portion 81b, as shown in FIG. 3. As shown in FIG. 9, the central portion 81b is notched toward a ceiling portion of the upper piece 81 with respect to the two left and right ends 81c and 81d in order to avoid interference with the rib 11e closer to the lower piece 82. As shown in FIG. 4, the width W1 of the inner wall 81a including the central portion 81b and the ends 81c and 81d is larger than the width W2 of the inner wall 82a (see FIG. 3).

As shown in FIGS. 7 and 9, the inner wall 81a that extends from the upper piece 81 overlaps the inner wall 82a that extends from the lower piece 82 with a predetermined overlap width at a position corresponding to the central portion of the body 11. On the other hand, the ends 81c and 81d of the inner wall 82a enclose and overlap an end region of the inner wall 82a at a predetermined interval at positions spaced apart from the central portion of the body 11 to the left and right, as shown in FIGS. 8 and 9. The blow-by gas passage 33 is formed in a region sandwiched between the inner wall 81a and the inner wall 82a.

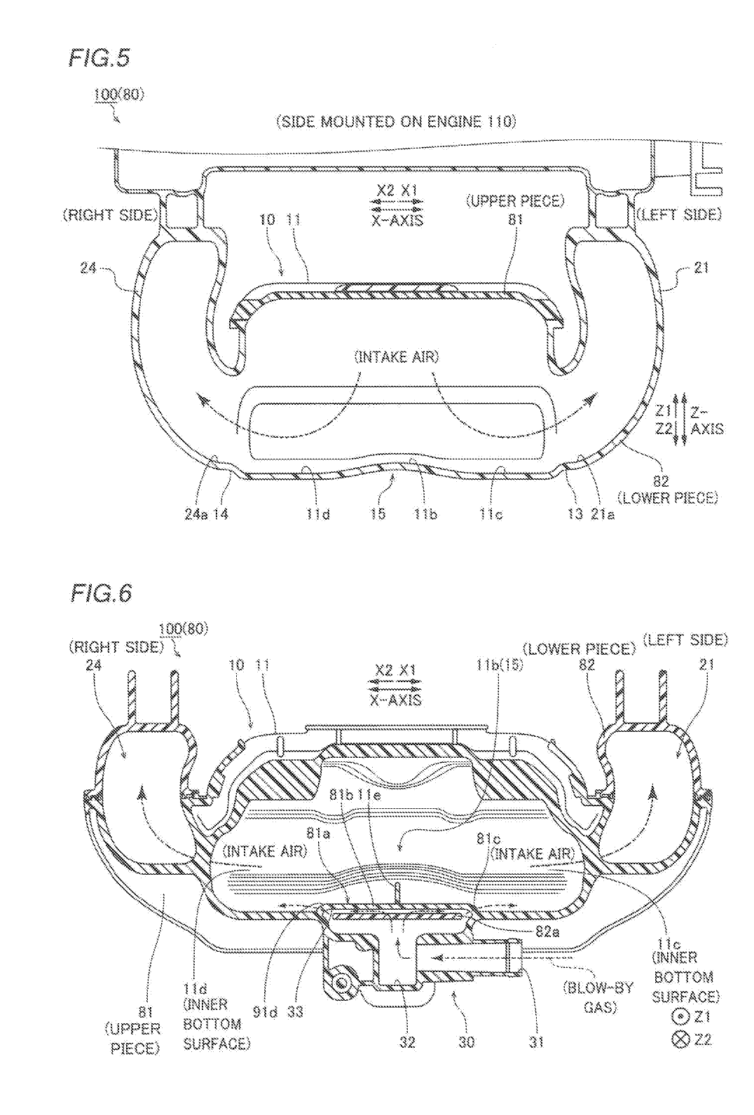

Therefore, the blow-by gas introduced from the blow-by gas introduction portion 31 into the introduction chamber 32 is first easily distributed in the left direction (X1 side) and the right direction (X2 side) through the blow-by gas passage 33 including the region sandwiched between the inner wall 81a and the inner wall 82a, as shown in FIG. 6. Then, the blow-by gas is jetted from a clearance (external gas introduction region) between the inner wall 82a and the end 81c of the inner wall 81a on the X1 side toward the left main pipe 21 (see FIG. 6) connected to the left end 13 of the surge tank 10, as shown in FIG. 9. Similarly, the blow-by gas is jetted from a clearance (external gas introduction region) between the inner wall 82a and the end 81d of the inner wall 81a on the X2 side toward the right main pipe 24 (see FIG. 6) connected to the right end 14 of the surge tank 10.

Therefore, the external gas introduction regions in the blow-by gas passage 33 are arranged at positions (inclined regions of the inner bottom surface) spaced apart in the left-right direction from a position that corresponds to the top of the convex portion 15 of the inner bottom surface of the surge tank 10, as shown in FIGS. 6 and 9. Thus, the blow-by gas is properly distributed to the left main pipe 21 and the right main pipe 24 through the blow-by gas passage 33 utilizing the negative pressure of the engine 110 (see FIG. 1), and is mixed with (diffused to) the intake air.

As described above, the blow-by gas is jetted into the surge tank 10 in the middle of downhill slopes from the central portion of the body 11 provided with the inner bottom surface 11b (convex portion 15), which is raised in the arrow Z1 direction, toward the left inner bottom surface 11c (X1 side) and the right inner bottom surface 11d (X2 side). Thus, when the blow-by gas recirculated to the engine 110 is introduced together with the intake air (fresh air) into the surge tank 10 through the blow-by gas supply portion 30, oil mist in a liquid drop form contained in the blow-by gas is prevented by the convex portion 15 from being accumulated in a region (a region in the vicinity of the inner bottom surface 11b at the central portion) in the surge tank 10 where the intake air is taken.

In other words, the oil flows down from the inner bottom surface 11b, which is relatively raised, to the left inner bottom surface 11c (X1 side) and the right inner bottom surface 11d (X2 side) and is constantly accumulated in the inner bottom surface 11c and the inner bottoms surface 11d, as shown in FIG. 5. Therefore, when the blow-by gas is introduced together with the intake air into the surge tank 10, the oil accumulated in the inner bottom surface 11c and the inner bottom surface 11d in the surge tank 10 is continuously sucked out through the left main pipe 21 provided in the vicinity of the lowermost portion of the left end 13 and the right main pipe 24 provided in the vicinity of the lowermost portion of the right end 14.

As shown in FIG. 5, the convex portion 15 is provided at a position at which intake air is taken such that oil reservoirs are spaced apart in the left-right direction, and hence the oil accumulated in the surge tank 10 is prevented from being splashed due to flow of the intake air taken quickly upon start of the engine 110 (see FIG. 1) and adhering to the throttle valve 120 (see FIG. 1) in the vicinity of the throttle body mounting portion 12.

As shown in FIGS. 1 and 2, the tip end 23a of the air intake pipe 22a, the tip end 23b of the air intake pipe 22b, the tip end 26a of the air intake pipe 25a, and the tip end 26b of the air intake pipe 25b that constitute the air intake pipe portion 20 are linearly arranged along the direction (X-axis direction) in which the body 11 of the surge tank 10 extends. The air intake apparatus 100 according to this embodiment is configured in the above manner.

According to this embodiment, the following effects can be obtained.

According to this embodiment, as hereinabove described, the air intake apparatus body 80 includes the single left main pipe 21 connected to the left end 13 of the surge tank 10, the single right main pipe 24 connected to the right end 14, the left air intake pipe group 22 that is connected to the left main pipe 21 and includes the two branched air intake pipes 22a and 22b, and the right air intake pipe group 25 that is connected to the right main pipe 24 and includes the two branched air intake pipes 25a and 25b. Thus, the single left main pipe 21 is connected to the left end 13 of the surge tank 10 while the single right main pipe 24 is connected to the right end 14 of the surge tank 10, and hence the intake air path length from the air intake 12a of the surge tank 10 to the connection (end 21a) of the left main pipe 21 and the intake air path length from the air intake 12a of the surge tank 10 to the connection (end 24a) of the right main pipe 24 can be equal to each other. Therefore, the intake air taken into the surge tank 10 can be equally distributed to the left main pipe 21 and the right main pipe 24. Consequently, variation in the amount of air distributed from the surge tank 10 to each of the left main pipe 21 and the right main pipe 24 connected to the surge tank 10 can be suppressed. Furthermore, the intake air can be properly distributed to the two air intake pipes 22a and 22b, which the left air intake pipe group 22 includes, through the single left main pipe 21, and the intake air can be properly distributed to the two air intake pipes 25a and 25b, which the right air intake pipe group 25 includes, through the single right main pipe 24.

According to this embodiment, the air intake pipe portion 20 is configured such that the air intake pipe length from the end 21a of the left main pipe 21 closer to the surge tank 10 to each of the tip ends 23a and 23b of the air intake pipes 22a and 22b in the left air intake pipe group 22 is equal to the air intake pipe length from the end 24a of the right main pipe 24 closer to the surge tank 10 to each of the tip ends 26a and 26b of the air intake pipes 25a and 25b in the right air intake pipe group 25. Thus, the intake air path length from the end 21a that corresponds to the left exit of the surge tank 10 to the tip end 23a of the air intake pipe 22a branched toward the corresponding cylinder of the engine 110, the intake air path length from the same end 21a to the tip end 23b of the air intake pipe 22a, the intake air path length from the end 24a that corresponds to the right exit of the surge tank 10 to the tip end 26a of the air intake pipe 25a branched toward the corresponding cylinder of the engine 110, and the intake air path length from the same end 24a to the tip end 26b of the air intake pipe 25b can be equal to each other. Therefore, equidistributivity of the intake air to the left air intake pipe group 22 (air intake pipes 22a and 22b) and the right air intake pipe group 25 (air intake pipes 25a and 25b) connected to the left main pipe 21 and the right main pipe 24, respectively can be effectively improved while variation in the amount of air distributed from the surge tank 10 to each of the left main pipe 21 and the right main pipe 24 connected to the surge tank 10 can be suppressed.

According to this embodiment, the surge tank 10 includes the convex portion 15 configured such that the portion of the inner bottom surface 11b that corresponds to a position provided with the throttle body mounting portion 12 protrudes inward of the surge tank 10 with respect to the inner bottom surface 11c of the left end 13 and the inner bottom surface 11d of the right end 14 of the surge tank 10 in the left-right direction. Thus, in the air intake apparatus 100 in which the blow-by gas (PCV gas) recirculated to the engine 110 is introduced together with the intake air (fresh air) into the surge tank 10, the oil (engine oil) contained in the blow-by gas (PCV gas) can be prevented by the convex portion 15 from being accumulated in the region in the surge tank 10 where the intake air is taken. Therefore, the oil accumulated in the surge tank 10 can be prevented from being splashed due to flow of the intake air taken quickly upon start of the engine 110 and adhering to the throttle valve 120 in the vicinity of the throttle body mounting portion 12. Consequently, fixation of the throttle valve 120 caused by adhesion of a deposit formed by altering the oil component to the throttle valve 120 can be prevented.

According to this embodiment, the end 21a of the left main pipe 21 connected to the surge tank 10 is provided in the vicinity of the lowermost portion of the left end 13 of the surge tank 10 in the left-right direction, and the end 24a of the right main pipe 24 connected to the surge tank 10 is provided in the vicinity of the lowermost portion of the right end 14 of the surge tank 10 in the left-right direction. Thus, in the air intake apparatus 100 in which the blow-by gas (PCV gas) recirculated to the engine 110 is introduced together with the intake air (fresh air) into the surge tank 10, the oil contained in the blow-by gas accumulated in the surge tank 10 can be continuously sucked out through the left main pipe 21 provided in the vicinity of the lowermost portion of the left end 13 and the right main pipe 24 provided in the vicinity of the lowermost portion of the right end 14. In other words, a state where an excessive amount of oil is accumulated in the surge tank 10 can be avoided. Therefore, generation of white smoke caused by combustion of a large amount of oil sucked by negative pressure at the time of start of the engine 110 in a combustion chamber (not shown) can be prevented.

According to this embodiment, the blow-by gas introduction portion 31 that introduces the blow-by gas (PCV gas) is provided in the vertical plane 11e at the central portion of the surge tank 10, and the blow-by gas passage 33 that distributes, to the left and right sides, the blow-by gas introduced from the blow-by gas introduction portion 31 is provided on the inner surface of the surge tank 10. Thus, the blow-by gas introduced from the blow-by gas introduction portion 31 can be mixed with the intake air while being properly distributed to each of the left main pipe 21 and the right main pipe 24 connected to the left end 13 and the right end 14 of the surge tank 10 in the left-right direction, respectively, through the blow-by gas passage 33. At this time, the blow-by gas (PCV gas) containing oil (engine oil) is prevented from directly contacting with the intake air (fresh air) immediately after the intake air is taken through the throttle body mounting portion 12 at the central portion of the surge tank 10 and being entrained in the intake air, and hence fixation of the throttle valve 120 caused by adhesion of the deposit formed by altering the oil component to the throttle valve 120 can be prevented.

According to this embodiment, the blow-by gas passage 33 is formed in the region where the inner wall 81a of the upper piece 81 that extends toward the lower piece 82 and the inner wall 82a of the lower piece 82 that extends toward the upper piece 81 overlap each other. Thus, the blow-by gas can be easily distributed into the surge tank 10 through the blow-by gas passage 33 including the region sandwiched between the inner wall 81a and the inner wall 82a.

According to this embodiment, the external gas introduction regions (clearance portion between the inner wall 81a and the end 81c (81d)) in the blow-by gas passage 33 to the surge tank 10 are arranged at the positions spaced apart in the left-right direction from the position in the surge tank 10 that corresponds to the top of the convex portion 15. Thus, when the blow-by gas is introduced together with the intake air into the surge tank 10, the oil component (liquid oil) in the blow-by gas can be prevented by the convex portion 15 from being accumulated in the region (the region in the vicinity of the central inner bottom surface 11b) in the surge tank 10 where the intake air is taken.

The embodiment disclosed this time must be considered as illustrative in all points and not restrictive. The range of the present invention is shown not by the above description of the embodiment but by the scope of claims for patent, and all modifications within the meaning and range equivalent to the scope of claims for patent are further included.

For example, while the present invention is applied to the air intake apparatus 100 mounted on the in-line four-cylinder engine 110 in the aforementioned embodiment, the present invention is not restricted to this. The present invention may be applied to an air intake apparatus for an in-line multi-cylinder engine having four or more even number of cylinders, such as an in-line six-cylinder engine or an in-line eight-cylinder engine. For example, the present invention is applicable to an in-line eight-cylinder engine including a “first air intake pipe group” formed by branching “one air intake pipe” into four air intake pipes and a “second air intake pipe group” formed by branching “the other air intake pipe” into four air intake pipes.

While the blow-by gas (PCV gas) is introduced into the surge tank 10 in the aforementioned embodiment, the present invention is not restricted to this. The air intake apparatus 100 may be configured to introduce EGR (exhaust gas recirculation) gas, which is part of exhaust gas discharged outward from the combustion chamber (cylinder) and recirculated to the engine 110, as the “external gas” according to the present invention into the surge tank 10. Also in the structure in which the exhaust gas (EGR gas) is recirculated to the engine 110, moisture contained in the EGR gas is prevented by the convex portion 15 in the surge tank 10 from being accumulated in the region in the surge tank 10 where the intake air is taken. Therefore, the moisture accumulated in the surge tank 10 can be prevented from being splashed due to flow of the intake air taken quickly upon start of the engine 110 and adhering to the throttle valve 120. Thus, malfunction (fixation) of the throttle valve 120 caused by freezing of the moisture at the time of start of the engine 110 in a cold region can be prevented.

Also in the aforementioned modification, the end 21a of the left main pipe 21 connected to the surge tank 10 is preferably provided in the vicinity of the lowermost portion of the left end 13 of the surge tank 10 in the left-right direction, and the end 24a of the right main pipe 24 connected to the surge tank 10 is preferably provided in the vicinity of the lowermost portion of the right end 14 of the surge tank 10 in the left-right direction. Thus, the moisture contained in the exhaust gas (EGR gas) accumulated in the surge tank 10 can be continuously sucked out through the left main pipe 21 provided in the vicinity of the lowermost portion of the left end 13 and the right main pipe 24 provided in the vicinity of the lowermost portion of the right end 14. In other words, a state where an excessive amount of moisture is accumulated in the surge tank 10 can be avoided. Therefore, generation of accidental fire in the combustion chamber caused by a large amount of water sucked by negative pressure at the time of start of the engine 110 can be prevented.

In the aforementioned modification, it is only required to provide an EGR gas introduction portion that introduces the exhaust gas (EGR gas) at the central portion of the surge tank 10 and to provide an EGR gas passage that distributes, to the left and right sides, the exhaust gas introduced from the EGR gas introduction portion on the inner surface of the surge tank 10. Thus, the exhaust gas introduced from the EGR gas introduction portion can be properly distributed to the left main pipe 21 and the right main pipe 24 connected to the left end 13 and the right end 14 of the surge tank 10 in the left-right direction, respectively, through the EGR gas passage and be mixed with intake air. Furthermore, direct contact of the exhaust gas containing moisture is prevented, and hence blocking of an EGR gas inlet of the EGR gas passage caused by freezing of the moisture in the vicinity of the EGR gas inlet at the time of operation of the engine 110 in a cold region can be prevented. The EGR gas introduction portion and the EGR gas passage are examples of the “external gas introduction portion” and the “external gas passage” in the present invention, respectively.

While the inner wall 81a of the upper piece 81 and the inner wall 82a of the lower piece 82 overlap each other such that the blow-by gas passage 33 is formed inside the body 11 in the aforementioned embodiment, the present invention is not restricted to this. For example, a member formed in advance with the “external gas passage” that distributes externally introduced blow-by gas to the left and right sides may be configured as a separate piece, this member may be incorporated at the time of bonding the upper piece 81 to the lower piece 82, and the “external gas introduction portion” according to the present invention may be arranged at the central portion of the surge tank.

While the air intake apparatus body 80 is made of resin (polyamide resin) in the aforementioned embodiment, the present invention is not restricted to this. In other words, the air intake apparatus body 80 including the surge tank 10 and the air intake pipe portion 20 may be made of metal.

While the “air intake apparatus” according to the present invention is mounted on the in-line four-cylinder engine for a motor vehicle in the aforementioned embodiment, the present invention is not restricted to this. The “air intake apparatus” according to the present invention may be mounted on an in-line multi-cylinder engine other than the in-line four-cylinder engine for a motor vehicle. As the in-line multi-cylinder engine, a gasoline engine, a diesel engine, a gas engine, or the like is applicable. Alternatively, the present invention is also applicable to an air intake apparatus mounted on an internal-combustion engine or the like placed on transportation equipment such as a train or a marine vessel or stationary equipment other than the transportation equipment in addition to the engine (internal-combustion engine) mounted on a common vehicle (motor vehicle).

### DESCRIPTION OF REFERENCE SIGNS

10 surge tank
11b, 11c, 11d inner bottom surface
12 throttle body mounting portion
13 left end (one end)
14 right end (the other end)
15 convex portion
20 air intake pipe portion
21 left main pipe (one air intake pipe)
21a, 24a end (portion connected to the surge tank)
22 left air intake pipe group (first air intake pipe group)
22a, 22b, 25a, 25b air intake pipe
23a, 23b, 26a, 26b tip end
24 right main pipe (the other air intake pipe)
25 right air intake pipe group (second air intake pipe group)
31 blow-by gas introduction portion (external gas introduction portion)
33 blow-by gas passage (external gas passage)
80 air intake apparatus body
81 upper piece (first member)
81a inner wall (first inner wall surface)
82 lower piece (second member)
82a inner wall (second inner wall surface)
100 air intake apparatus
110 engine (in-line multi-cylinder engine)

1. An air intake apparatus mounted on an in-line multi-cylinder engine, comprising:
a surge tank that includes a throttle body mounting portion at a central portion thereof;
one air intake pipe, which is single, and the other air intake pipe, which is single, connected to one end and the other end of the surge tank in a left-right direction, respectively;
a first air intake pipe group that is connected to the one air intake pipe and includes a plurality of branched air intake pipes; and
a second air intake pipe group that is connected to the other air intake pipe and includes the same number of branched air intake pipes as the plurality of branched air intake pipes.

2. The air intake apparatus according to claim 1, wherein
an air intake pipe length from an end of the one air intake pipe closer to the surge tank to a tip end of an individual air intake pipe in the first air intake pipe group is equal to an air intake pipe length from an end of the other air intake pipe closer to the surge tank to a tip end of an individual air intake pipe in the second air intake pipe group.

3. The air intake apparatus according to claim 1, wherein
the surge tank further includes a convex portion configured such that a portion of an inner bottom surface that corresponds to a position provided with the throttle body mounting portion protrudes inward of the surge tank with respect to inner bottom surfaces of the one end and the other end of the surge tank in the left-right direction.

4. The air intake apparatus according to claim 1, wherein
portions of the one air intake pipe and the other air intake pipe connected to the surge tank are provided in the vicinity of lowermost portions of the one end and the other end of the surge tank in the left-right direction, respectively.

5. The air intake apparatus according to claim 1, wherein
an external gas introduction portion that introduces external gas is provided at the central portion of the surge tank, and
an external gas passage that distributes, to left and right sides, the external gas introduced from the external gas introduction portion is provided inside the surge tank.

6. The air intake apparatus according to claim 5, wherein
an air intake apparatus body including the surge tank is formed by facing and bonding a first member and a second member to each other, and
the external gas passage is formed in a region where a first inner wall surface of the first member that extends toward the second member and a second inner wall surface of the second member that extends toward the first member overlap each other.

7. The air intake apparatus according to claim 3, wherein
an external gas passage that distributes, to left and right sides, external gas introduced from an external gas introduction portion that introduces the external gas is provided inside the surge tank, and
external gas introduction regions to the surge tank in the external gas passage are arranged at positions spaced apart in the left-right direction from a position in the surge tank that corresponds to a top of the convex portion on the inner bottom surface.
